(19) United States
(12) Patent Application Publication
(10) Pub. No.: US 2026/0100888 A1
(43) Pub. Date: Apr. 9, 2026

(54) ML CAPABILITY EXCHANGE AND AUTHORIZATION FOR RRM

(71) Applicant: Nokia Technologies Oy, Espoo (FI)

(72) Inventors: Ethiraj ALWAR, Bangalore (IN); Amaanat ALI, Espoo (FI)

(73) Assignee: Nokia Technologies Oy, Espoo (FI)

(21) Appl. No.: 19/111,913

(22) PCT Filed: Aug. 22, 2023
(86) PCT No.: PCT/EP2023/073037

§ 371 Date: Mar. 14, 2025

(30) Foreign Application Priority Data
Sep. 30, 2022 (IN) 202241056215

(51) Int. Cl. H04L 41/16; H04W 24/02

(52) U.S. Cl. CPC H04L 41/16; H04W 24/02

(57) ABSTRACT

The present invention provides apparatuses, methods, computer programs, computer program products and computer-readable media for ML capability exchange and authorization for RRM. The method comprises receiving, from a network entity, an enquiry for providing a machine learning, ML, capability of the user equipment, the enquiry including an ML filter, indicating at least one ML algorithm available at the network entity, generating ML capability information indicating at least one ML model available at the user equipment based on the ML filter received from the network entity, and transmitting the generated ML capability information to the network entity.

### FIELD OF THE INVENTION

Various example embodiments relate to apparatuses, methods, systems, computer programs, computer program products and computer-readable media for ML capability exchange and authorization for RRM.

### ABBREVIATIONS

2CC CA—two component carrier CA
3CC CA—three component carrier CA
5G—5th Generation
AI—Artificial Intelligence
AP—Access Point
CA—Carrier Aggregation
EN-DC—E-UTRAN New Radio—Dual Connectivity
gNB—5G/NR base station
HO—Handover
MDT—Minimization of Drive Test
ML—Machine Learning
NGAP—Next Generation Application Protocol
NR—New Radio
RAN—Radio Access Network
RAT—Radio Access Technology
RRC—Radio Resource Control
RRM—Radio Resource Management
UE—User Equipment
UL—Uplink
E-UTRAN—Evolved Universal Terrestrial Radio Access Network

### BACKGROUND

Certain aspects of the present invention relate to artificial intelligence (AI)/machine learning (ML) in NG-RAN. In the future RAN network nodes are expected to host/support a wide variety of Machine Learning (ML) based algorithms that are expected to provide inference (Output) as shown in FIG. 1 to one or more consumers of the inference (i.e. Actor). The actor(s) may or may not be co-located in the same network node and as such the RAN3 network interfaces X2/Xn and the RAN-Core interface NG-AP will need to support information elements (IE's) to carry information between different network nodes.

In the following, there is provided a description of the functions and data/information flows illustrated in FIG. 1, as described in 3GPP TR 37.817.

Data Collection 11 is a function that provides input data to Model training and Model inference functions. AI/ML algorithm specific data preparation (e.g., data pre-processing and cleaning, formatting, and transformation) is not carried out in the Data Collection function.

Examples of input data may include measurements from UEs or different network entities, feedback from Actor, output from an AI/ML model.

Training Data: Data needed as input for the AI/ML Model Training function.

Inference Data: Data needed as input for the AI/ML Model Inference function.

Model Training 12 is a function that performs the AI/ML model training, validation, and testing which may generate model performance metrics as part of the model testing procedure. The Model Training function is also responsible for data preparation (e.g., data pre-processing and cleaning, formatting, and transformation) based on Training Data delivered by a Data Collection function, if required.

Model Deployment/Update: Used to initially deploy a trained, validated, and tested AI/ML model to the Model Inference function or to deliver an updated model to the Model Inference function.

Model Inference 13 is a function that provides AI/ML model inference output (e.g., predictions or decisions). Model Inference function may provide Model Performance Feedback to Model Training function when applicable. The Model Inference function is also responsible for data preparation (e.g., data pre-processing and cleaning, formatting, and transformation) based on Inference Data delivered by a Data Collection function, if required.

Output: The inference output of the AI/ML model produced by a Model Inference function.

Model Performance Feedback: It may be used for monitoring the performance of the AI/ML model, when available.

Actor 14 is a function that receives the output from the Model Inference function and triggers or performs corresponding actions. The Actor may trigger actions directed to other entities or to itself.

Feedback: Information that may be needed to derive training data, inference data or to monitor the performance of the AI/ML Model and its impact to the network through updating of KPIs and performance counters.

The 5G Networks supports mechanism and procedures to retrieve UE Capability from the UE based on which gNB configures the UE. The current specifications offers two mechanism:
Network Triggered Filter based Enquiry Procedure-gNB can send a UE Capability Enquiry Procedures to the UE with a filter which is used by the UE to send the corresponding capabilities, and
Asynchronous UE Assistance Information procedure from UE to gNB, which contains notifications of impairments, which the gNB can use for further updating the configurations to the UE.

Hence, the signaling and procedures in 5G are designed with the following principles:
UE Capability Enquiry is tightly coupled with network capability. For example, if gNB supports Carrier Aggregation, include the frequency band filter in UE Capability Enquiry based on the bands supported by the gNB cells.
Once enquired, these capabilities change very rarely or do not change at all and hence the Capability retrieval from UE is done once by gNB and sent to core for subsequent usage.

However, with AIML based use cases and especially with the AIML capability in UE, there is a new approach to the capability evolution
UE Capability in terms of AIML is not tightly coupled with the AIML capability of RAN. It will be possible for the UE to download new AIML models and hence can report new capabilities.
There is a lifecycle involved from the time a model is downloaded to the time the model is ready for usage. For example, a model that is downloaded in a UE can be in any of the states-Available, Training in progress, Training Complete, Inference Ready, Re-training, etc.

The ML Capability is related to the Machine Learning Capabilities. Such capability typically indicates one or more ML Models and the associated attributes.

Current procedures for retrieving the UE capabilities, as illustrated in FIG. 2, include
First Time UE Capability Enquiry and sending it to Core for subsequent usage, and
Subsequent UE Assistance Information from UE indicating temporary impairment based on which gNB can adjust the configuration temporarily

The First Time UE Capability Enquiry consists of the UE Capability Enquiry and the RRC Reconfiguration. In step S21, the gNB sends the UE capability enquiry to the UE, which responds in step S22 with the UE capability information to the gNB. In step S23, the gNB transmits and UE capability information indication to the 5G core. Then, in step S24, the gNB transmits the RRC reconfiguration to the UE.

The Subsequent UE Assistance Information comprises UE Assistance Information (indicating a temporary impairment) and RRC Reconfiguration (for addressing the temporary impairment). Further, the Subsequent UE Assistance Information comprises UE Assistance Information (without any impairment) and RRC Reconfiguration (initial configuration).

In step S25, the gNB sends the initial UE message to the 5G core, which responds with an initial context setup request message to the gNB in step S26. The gNB then transmits the RRC reconfiguration to the UE in a step S27.

In a step S28, the UE transmits the UE assistance information to the gNB, which again provides a RRC reconfiguration message to the UE in a step S29.

### SUMMARY

Various example embodiments aim at addressing at least part of the above issues and/or problems and drawbacks.

It is an object of various example embodiments to provide apparatuses, methods, systems, computer programs, computer program products and computer-readable media for ML capability exchange and authorization for RRM.

According to an aspect of various example embodiments there is provided a method for use in a user equipment, comprising:
receiving, from a network entity, an enquiry for providing a machine learning, ML, capability of the user equipment, the enquiry including an ML filter, indicating at least one ML algorithm available at the network entity,
generating ML capability information indicating at least one ML model available at the user equipment based on the ML filter received from the network entity, and
transmitting the generated ML capability information to the network entity. According to another aspect of various example embodiments there is provided a method for use in a network entity, comprising:
transmitting, to a user equipment, an enquiry for providing a machine learning, ML, capability of the user equipment, the enquiry including an ML filter indicates at least one ML algorithm available at the network entity,
receiving, from the user equipment, ML capability information indicating the ML capability of the user equipment based on the ML filter,
associating the received ML capability information with specific radio resource management, RRM, functions, and
authorizing usage of selected ones of the ML models indicated by the ML capability information for the specific RRM functions.

According to another aspect of various example embodiments there is provided a method for use in a network entity, comprising:
holding a list including an identification of at least one user equipment connected to the network entity and information regarding at least one machine learning, ML, model available at the user equipment in association with each other,
authorizing usage of at least one of the ML models of the user equipment indicated in the list for specific RRM functions.

According to another aspect of various example embodiments there is provided an apparatus for use in a user equipment, comprising
means for receiving, from a network entity, an enquiry for providing a machine learning, ML, capability of the user equipment, the enquiry including an ML filter, indicating at least one ML algorithm available at the network entity,
means for generating ML capability information indicating at least one ML model available at the user equipment based on the ML filter received from the network entity, and
means for transmitting the generated ml capability information to the network entity.

According to another aspect of various example embodiments there is provided an apparatus for use in a network entity, comprising
means for transmitting, to a user equipment, an enquiry for providing a machine learning, ML, capability of the user equipment, the enquiry including an ML filter indicates at least one ML algorithm available at the network entity,
means for receiving, from the user equipment, ML capability information indicating the ML capability of the user equipment based on the ML filter,
means for associating the received ML capability information with specific radio resource management, RRM, functions, and
means for authorizing usage of selected ones of the ML models indicated by the ML capability information for the specific RRM functions.

According to another aspect of various example embodiments there is provided an apparatus for use in a network entity, comprising
means for holding a list including an identification of at least one user equipment connected to the network entity and information regarding at least one machine learning, ML, model available at the user equipment in association with each other, and
means for authorizing usage of at least one of the ML models of the user equipment indicated in the list for specific RRM functions

According to another aspect of the present invention there is provided a computer program product comprising code means adapted to produce steps of any of the methods as described above when loaded into the memory of a computer.

According to a still further aspect of the invention there is provided a computer program product as defined above, wherein the computer program product comprises a computer-readable medium on which the software code portions are stored.

According to a still further aspect of the invention there is provided a computer program product as defined above, wherein the program is directly loadable into an internal memory of the processing device.

According to an aspect of various example embodiments there is provided a computer readable medium storing a computer program as set out above.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Further aspects and features of the present invention are set out in the dependent claims.

### BRIEF DESCRIPTION OF THE DRAWINGS

These and other objects, features, details and advantages will become more fully apparent from the following detailed description of various aspects/embodiments which is to be taken in conjunction with the appended drawings, in which:

FIG. 1 is a diagram illustrating a functional framework for RAN intelligence;

FIG. 2 is a signaling diagram illustrating an example of a procedure for retrieving UE capability according to the state of the art.

FIG. 3 is a signaling diagram illustrating an example of the association of the ML model, the UE radio capability and the RRM context for authorization.

FIG. 4 is a signaling diagram illustrating an example of the dynamic notification of updated ML capabilities.

FIG. 5 is a signaling diagram illustrating an example of the dynamic authorization of an UE AIML model for a specific RRM context.

FIG. 6 is a flowchart illustrating an example of a method according to certain aspects of the present invention.

FIG. 7 is a flowchart illustrating another example of a method according to certain aspects of the present invention.

FIG. 8 is a flowchart illustrating another example of a method according to certain aspects of the present invention.

FIG. 9 is block diagram illustrating an example of an apparatus according to certain aspects of the present invention.

FIG. 10 is block diagram illustrating another example of an apparatus according to certain aspects of the present invention.

FIG. 11 is block diagram illustrating another example of an apparatus according to certain aspects of the present invention.

FIG. 12 is block diagram illustrating another example of an apparatus according to certain aspects of the present invention.

FIG. 13 is block diagram illustrating another example of an apparatus according to certain aspects of the present invention.

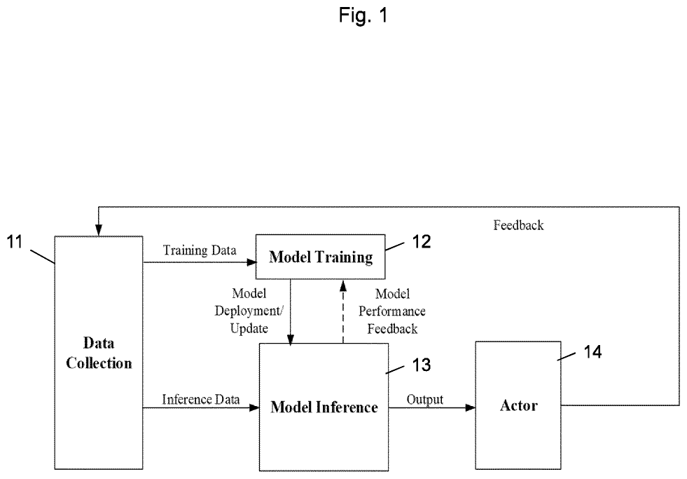

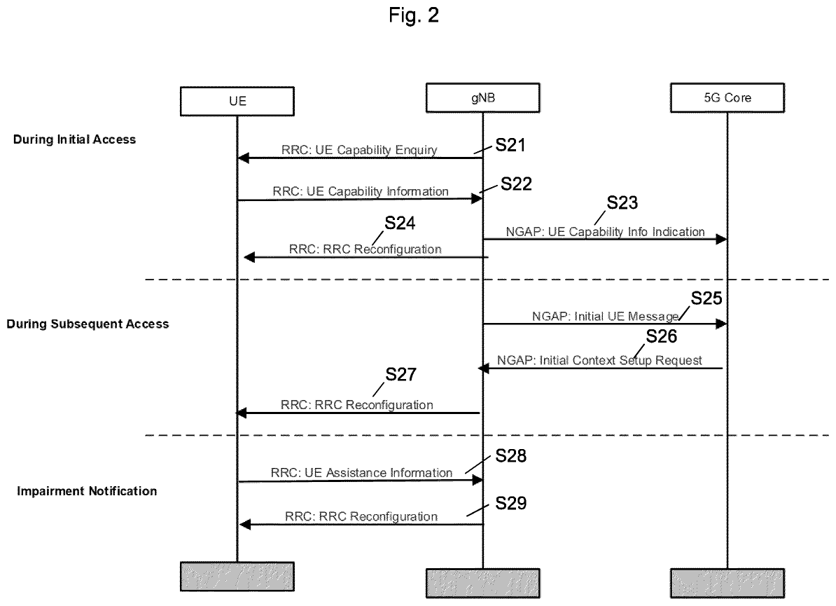

### DETAILED DESCRIPTION

The present disclosure is described herein with reference to particular non-limiting examples and to what are presently considered conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology, which is directly related thereto. Such terminology is only used in the context of the presented non-limiting examples, and does naturally not limit the disclosure in any way. Rather, any other communication or communication related system deployment, etc. might also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to certain aspects of the present invention, there are proposed different methods for enhancing the UE capability retrieval related to ML functionality.

In a method 1, there is provided a mechanism to associate AIML Models and RRM Functions/context with UE Radio Capabilities and authorize the usage of AIML Model in a specific RRM context.

That is, based on the operator configurations or ML Algorithms that are configured/activated in the gNB, the gNB triggers the ML Capability Enquiry procedure to the UE with a ML Filter.

It is expected that the UE may support different AIML Capabilities that correspond to different components/RRM Functions.

Hence, it is expected that a given AIML Model that a UE supports will have influence on one more feature set/feature set combinations reported by the UE.

Thus, according to certain aspects of the present invention, there is proposed a method wherein a gNB can retrieve the AIML Model supported by the UE and authorize the usage of such models in specific RRM Context or in the scope of specific RRM Functions.

In this connection, it is noted that RRM Function and Context is related to the Radio Resource Management Functionality. For example, mobility, carrier aggregation and the like are referred to as RRM Function/Context.

The feature sets and feature set combination are related to the UE Radio Capabilities. This typically indicates the capability of a given UE for a given feature. For example, support of 2CC or 3CC CA. Additionally, the UE should also report feature sets and feature set combinations where the UE is capable of using the ML Model (if present).

As an example, the RRM Function relates to Beam Prediction. In the ML Capability Enquiry the gNB asks the UE to report all the band/band combinations wherein a given ML-assisted beam reporting is applicable, and to report those combinations where the prediction accuracy is over 90%. The UE then reports the supported capabilities in the context of associated feature set and feature set combinations (radio capabilities). As to the Authorization, it is determined whether the UE is authorized to use ML-based beam prediction in intra-Frequency HO, Inter-Frequency HO, EN-DC Call, Inter-RAT HO etc. This is performed in the gNB.

That is, as an example regarding the authorization in connection with the ML model, the RRM context/function, the ML capability and the ML capability filter, when the ML model relates to Beam Prediction, the RRM Function/Context where Beam Prediction ML Model can be used (authorized by gNB) includes intra-Frequency HO, Inter-Frequency HO, EN-DC Call, Inter-RAT HO. This is based on operator configuration. Then, the ML Capability indicates feature sets where UE supports the model, e.g. specific frequency bands, carrier frequencies, and the like, as well as Model Attributes, like Model Status, Model Maturity, etc. The ML Capability Filter is a specific configuration filter for which gNB wants the UE to report ML Capability.

In method 2, there is provided a mechanism for more dynamic notification of new/updated capabilities.

According to this method 2, a previously downloaded model can be in different states of maturity such as “Available”, “Training in progress”, “Training Complete”, “Inference Ready”, “Re-training” etc. Whenever there is a transition from one state to another, there is a need to notify it to the RAN.

UE can download a new model, which is already trained and ready for inference. This should be notified to the RAN for authorization.

Such an update does not necessarily trigger immediate action from the network to retrieve more details about the updated capability.

In a method 3, there is provided a dynamic authorization of an UE AIML Model for a specific RRM Context.

Once the UE has a new model, it can be applied in different RRM Context or Function. For example, when the UE reports the AIML based inference capability to report best beam, such a capability can be used in different RRM Contexts such as Inter-Frequency HO, Inter-RAT HO, EN-DC Scenario etc.

The RAN decides to control the RRM Context or RRM Function where a given UE AIML can be applied so that RAN can monitor the effects and results of such actions. Such an approach is also needed during the Model validation phase

Two methods, that are proposed to achieve this include:
Authorization to use new AIML Model in each specific RRC Message e.g. Paging or RRC Reconfiguration
Authorization to use new AIML Model in specific RRM Contexts thereby decoupling such information being associated in each RRC Procedure. For example, gNB can authorize a UE to perform beam prediction in all Intra-Frequency Handover Scenario.

It is noted that these methods 1 to 3 can of course be combined with each other.

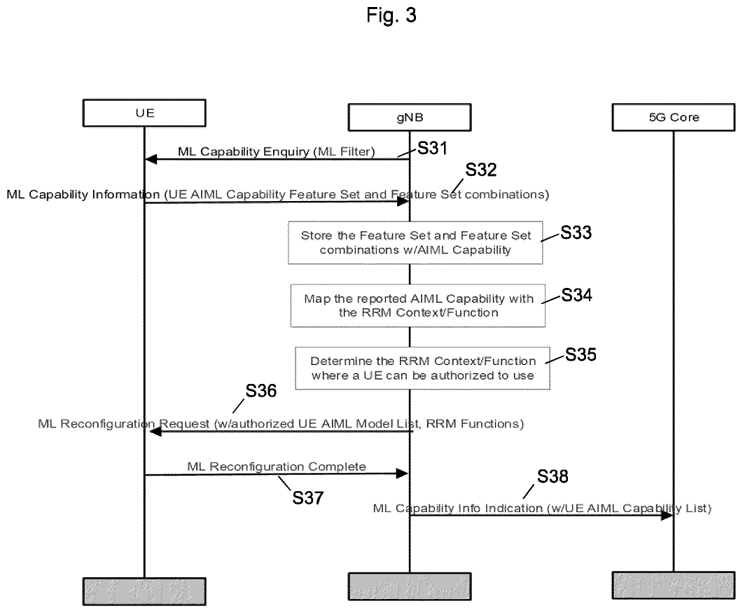

The method 1 providing a mechanism to associate AIML Models, RRM Functions with UE Radio Capabilities and authorize the usage of AIML Model in specific context will now be described in more detail with respect to FIG. 3.

In step S31, the gNB triggers ML Capability Enquiry with the UE using a ML Capability Filter. This filter shall support both options to query specific set AIML Capabilities associated with the AIML Capabilties supported by the gNB or complete query of all capabilities supported by the UE. An implementation of the filter indicates the UE to report all the band/band combinations wherein a given ML assisted function (e.g. improved beam reporting) would be applicable and only to report those combinations where the prediction accuracy is over 90%.

In a step S32, the UE reports the ML capability information to the gNB.

In another example, the network may ask the UE to report only those feature set/Feature set combinations for a given band/band combination that support a combination of ML assistance (e.g. beam prediction+improved measurement accuracy or beam prediction+improved measurement accuracy+lowered overhead in reporting). The UE then reports in the step S32 the supported capabilities in the context of associated feature set and feature set combinations marking the capability container in accordance with the network requested filter. In a step S33, the gNB stores the reported capabilities and builds a mapping of the reported AIML Capabilities with the UE Radio Capability and RRM Context/Function in a step S34. RRM Context/Function is an operator configurable parameter through which the operator can indicate the preferences on how to authorize the AIML Model. The preference can indicate the scope of the authorization (RRM Context/RRM Function, Architecture Options, UE Category etc . . . ). That is, in step S35, the gNB determines the RRM context/function where a UE can be authorized to use.

In a step S36, the gNB triggers the ML Reconfiguration Request to the selected UE to authorize the usage of AIML Model in a specific context. The gNB can install additional measurements or MDT Configurations to measure the performance of such actions. The UE responds back indicating the completion of the ML Authorization request in a step S37. This step is required to ensure the gNB and UE are in synchronization with respect to what ML assisted functions can be initialized in the UE.

In a step S38, the gNB informs the 5G core (a central network entity) about the ML Authorization and synchronizes the UE capability container containing the ML capabilities.

Further, it is noted that the procedure of the authorization comprises the following:
a) Authorization (authorize the usage of ML model for one or more RRM Function/contexts)
b) De-authorization (remove the usage of ML Model completely)
c) Re-authorization (usage of ML model for a different set of RRM Functions/contexts).

Additionally, it is noted that the authorization may be done for a single UE or for a set of UEs, if a specific criteria is met.

According to an alternative embodiment, the exchange of such filter and exchange of UE capabilities may be triggered by the core network to allow a system level wide alignment that may involve the gNB.

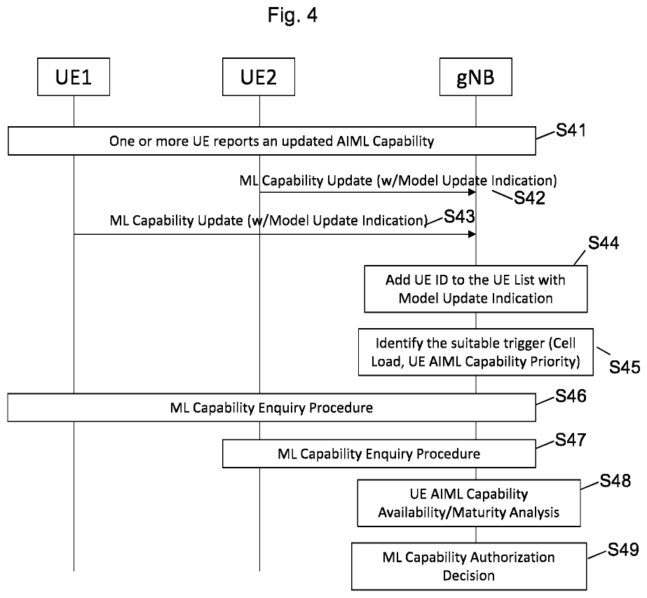

The method 2, that provides a mechanism for more dynamic notification of new/updated capabilities in described below with reference to FIG. 4.

In a step S41, whenever there is an update in the AIML Capability of the UE (either due to a new model or state change of an existing model or the user chooses to subscribe to a new ML assisted functionality as the UE is upgraded), the UE indicates this to the gNB. In particular, the UEs 1 and 2 transmit a ML capability update to the gNB in steps S42 and S43, respectively.

Such an indication can be piggybacked in UL RRC Procedure (e.g. as part of RRC measurement report or RRC reconfiguration complete) or it can be implemented as a separate notification procedure in the UL as shown in FIG. 4.

In a step S44, the gNB adds the ID of the UE to the UE list with the model update indication, and identifies the suitable trigger (e.g. cell load, UE AIML capability priority) in a step S45.

That is, the gNB maintains a list of UE and the corresponding model update notifications. In the step S45, the gNB checks the different inputs to decide when to trigger the ML Capability Enquiry procedure. It shall consider the priority of the new capability reported, model maturity, UE population supporting similar model and cell load among other factors. gNB can also authorize the limited usage (i.e. usage of the model in specific RRM Context/Scope) of the model during the model validation phase.

In steps S46 and S47, the ML capability enquiry procedure is performed between the UE1, UE2 and the gNB. In steps S48 and S49, the gNB performs the UE AIML capability availability/maturity analysis and the ML capability authorization decision.

According to certain aspects of the present invention, the processing in FIG. 4 is triggered after there is a sizeable UE population with a given AI/ML capability. As an alternative, also an immediate processing per UE is possible.

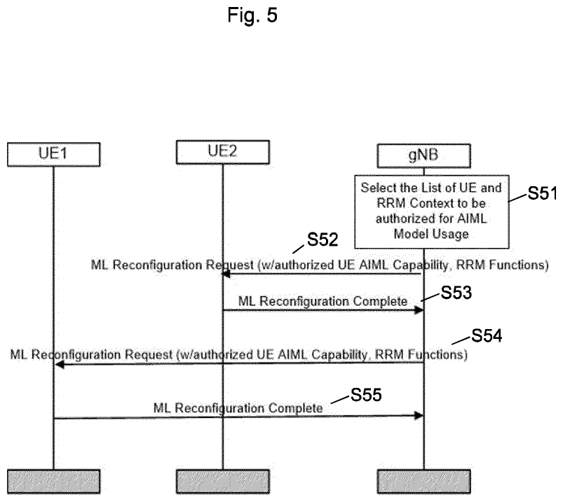

In the method 3, which is described with respect to FIG. 5, the gNB selects the list of UEs for which to activate a specific AIML model for a given RRM Context/Function in a step S51. The gNB sends ML Reconfiguration request to those selected UEs to authorize the use. In FIG. 5, the gNB sends the ML reconfiguration request including the authorized AIML capability and RRM function to the UE2 in step S52 and to the UE1 in step S54 and receives ML configuration complete messages from the UE2 in step S53 and from the UE1 in step S55, respectively.

In the foregoing, there have been described the three proposed methods according to certain aspects of the present invention.

As indicated above, the method 1 provides a mechanism to associate AIML Models, RRM Functions with UE Radio Capabilities and authorize the usage of AIML Model in specific context as the base method. The base method majorly comprises of
1. ML Capability Enquiry
2. Determination of the ML Model Usage in specific RRM Function
3. Authorization of ML Usage in specific RRM Context/Function

The method 2 is about the ML Capability Update from UE to RAN, which is used to trigger method 1 dynamically.

The method 3 is about Dynamic Authorization of an UE AIML Model for a specific RRM Context and is related to above-mentioned point 3 of method 1. Further, it is also applicable when the method 2 decides to authorize ML model for a given RRM Function. Thus, the gNB has the functionality to decide when to activate ML model in one or more UE based on the ML Capability/maturity assessment. This could be based on operator-configured policies. For example, one policy could be to activate beam prediction ML Model only if X % of UE support the model with Y % of accuracy.

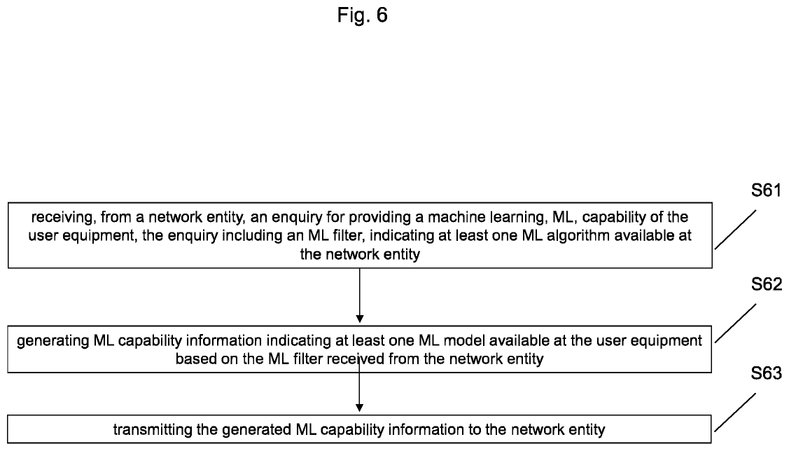

In the following, a more general description of example versions of the present invention is made with respect to FIGS. 6 to 13.

FIG. 6 is a flowchart illustrating an example of a method according to some example versions of the present invention.

According to example versions of the present invention, the method may be implemented in or may be part of a user equipment, or the like. The method comprises receiving, in a step S61, from a network entity, an enquiry for providing a machine learning, ML, capability of the user equipment, the enquiry including an ML filter, indicating at least one ML algorithm available at the network entity, generating, in a step S62, ML capability information indicating at least one ML model available at the user equipment based on the ML filter received from the network entity, and transmitting the generated ML capability information to the network entity in a step S63.

According to some example versions of the present invention, the method further comprises receiving, from the network entity, a ML reconfiguration request including an information indicating the ML models, which are authorized by the network entity for specific radio resource management, RRM, functions.

According to some example versions of the present invention, the method further comprises generating an update notification indicating that the ML capability information of the user equipment has been updated, and transmitting the notification to the network entity.

According to some example versions of the present invention, the method further comprises receiving, from the network entity, an inquiry for providing updated ML capability of the user equipment, the enquiry including the ML filter, generating ML capability update information indicating at least one updated ML model available at the user equipment based on the ML filter received from the network entity, and transmitting the generated ML capability update information to the network entity.

According to some example versions of the present invention, the update notification is generated when a state of a ML model changes, when a new ML model is downloaded to the user equipment, or when the user equipment subscribes to a new ML assisted functionality.

According to example versions of the present invention, the method may be implemented in or may be part of a network entity, like a base station, a gNB or the like. The method comprises transmitting, in a step S71, to a user equipment, an enquiry for providing a machine learning, ML, capability of the user equipment, the enquiry including an ML filter indicates at least one ML algorithm available at the network entity, receiving, from the user equipment, ML capability information indicating the ML capability of the user equipment based on the ML filter in a step S72, associating, in a step S73, the received ML capability information with specific radio resource management, RRM, functions, and authorizing usage of selected ones of the ML models indicated by the ML capability information for the specific RRM functions in a step S74.

According to some example versions of the present invention, the authorizing comprises authorization of allowing the usage of selected ones of the ML models for the specific RRM functions, de-authorization of prohibiting the usage of selected ones of the ML models for the specific RRM functions, and re-authorization of allowing the usage of selected ones of the ML models for a different set of RRM functions.

According to some example versions of the present invention, the method further comprises transmitting, to the user equipment, a ML reconfiguration request including information indicating the authorization of the ML models, which are authorized for the specific RRM functions.

According to some example versions of the present invention, the method further comprises receiving, from the user equipment, an update notification indicating that the ML capability information of the user equipment has been updated, and storing an identification of the user equipment in connection with an information that ML capability of the user equipment has been updated.

According to some example versions of the present invention, the method further comprises transmitting, to the user equipment, an enquiry for providing updated ML capability of the user equipment, the enquiry including the ML filter, receiving, from the user equipment, ML capability update information indicating the updated ML capability of the user equipment based on the ML filter, associating the received ML capability update information with specific radio resource management, RRM, functions, and authorizing usage of selected ones of the updated ML models indicated by the ML capability update information for the specific RRM functions.

According to some example versions of the present invention, the method further comprises transmitting, to the user equipment, an updated ML reconfiguration request including information indicating the updated authorization of the ML models, which are authorized for the specific RRM functions.

According to some example versions of the present invention, the method further comprises transmitting, to a central network entity, a ML capability information indication indicating the ML capability of the UE and the authorization of the ML models.

According to some example versions of the present invention, the method further comprises transmitting the ML capability information indication to the central network entity when determining that the UE moves to radio resource connection, RRC, idle state.

According to some example versions of the present invention, the method further comprises transmitting the ML capability information indication to another network node, when it is determined that the UE has been handed over to the another network node.

According to example versions of the present invention, the method may be implemented in or may be part of a network entity, like a base station, a gNB or the like. The method comprises holding a list including an identification of at least one user equipment connected to the network entity and information regarding at least one machine learning, ML, model available at the user equipment in association with each other in a step S81, and authorizing usage of at least one of the ML models of the user equipment indicated in the list for specific RRM functions in a step S82.

According to some example versions of the present invention, authorizing the usage of the at least one of the ML models of the user equipment relates to a specific radio resource connection, RRC, procedure or one or more specific scenarios.

According to some example versions of the present invention, the authorizing comprises authorization of allowing the usage of at least one of the ML models for the specific RRM functions, de-authorization of prohibiting the usage of at least one of the ML models for the specific RRM functions, and re-authorization of allowing the usage of at least one of the ML models for a different set of RRM functions.

According to some example versions of the present invention, the method further comprises transmitting, to the user equipment, a ML reconfiguration request including information indicating the authorization of the ML models, which are authorized for the specific RRM functions.

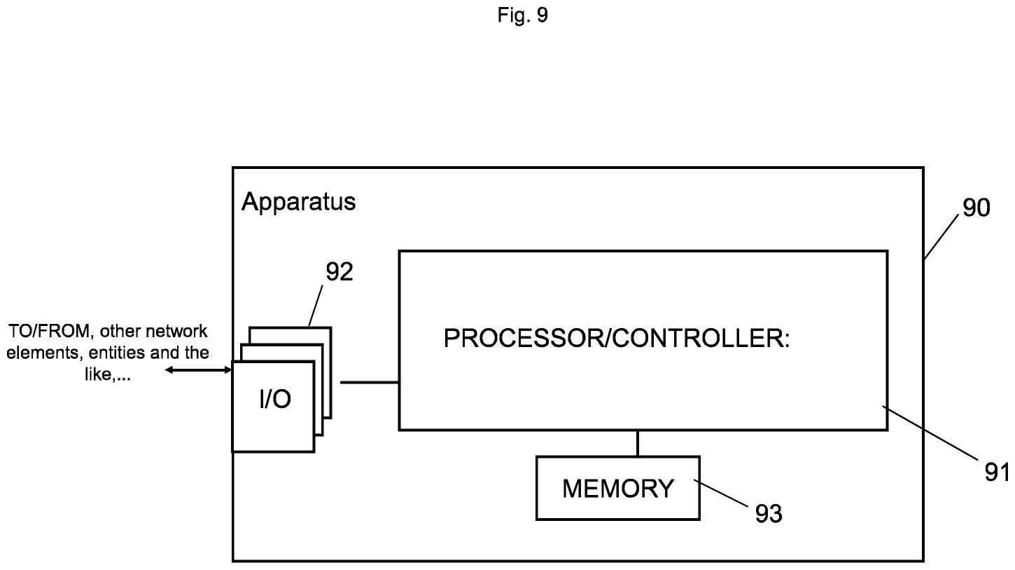

FIG. 9 is a block diagram illustrating another example of an apparatus according to some example versions of the present invention.

In FIG. 9, a block circuit diagram illustrating a configuration of an apparatus 90 is shown, which is configured to implement the above described various aspects of the invention. It is to be noted that the apparatus 90 shown in FIG. 9 may comprise several further elements or functions besides those described herein below, which are omitted herein for the sake of simplicity as they are not essential for understanding the invention. Furthermore, the apparatus may be also another device having a similar function, such as a chipset, a chip, a module etc., which can also be part of an apparatus or attached as a separate element to the apparatus, or the like.

The apparatus 90 may comprise a processing function or processor 91, such as a CPU or the like, which executes instructions given by programs or the like. The processor 91 may comprise one or more processing portions dedicated to specific processing as described below, or the processing may be run in a single processor. Portions for executing such specific processing may be also provided as discrete elements or within one or further processors or processing portions, such as in one physical processor like a CPU or in several physical entities, for example. Reference sign 102 denotes transceiver or input/output (I/O) units (interfaces) connected to the processor 91. The I/O units 92 may be used for communicating with one or more other network elements, entities, terminals or the like. The I/O units 92 may be a combined unit comprising communication equipment towards several network elements, or may comprise a distributed structure with a plurality of different interfaces for different network elements. The apparatus 90 further comprises at least one memory 93 usable, for example, for storing data and programs to be executed by the processor 91 and/or as a working storage of the processor 91.

The processor 91 is configured to execute processing related to the above-described aspects.

In particular, the apparatus 90 may be implemented in or may be part of a user equipment, and may be configured to perform processing as described in connection with FIG. 6.

Thus, according to some example versions of the present invention, there is provided an apparatus 90 for use in a user equipment, comprising at least one processor 91, and at least one memory 93 for storing instructions to be executed by the processor 91, wherein the at least one memory 93 and the instructions are configured to, with the at least one processor 91, cause the apparatus 90 at least to perform receiving, from a network entity, an enquiry for providing a machine learning, ML, capability of the user equipment, the enquiry including an ML filter, indicating at least one ML algorithm available at the network entity, generating ML capability information indicating at least one ML model available at the user equipment based on the ML filter received from the network entity, and transmitting the generated ML capability information to the network entity.

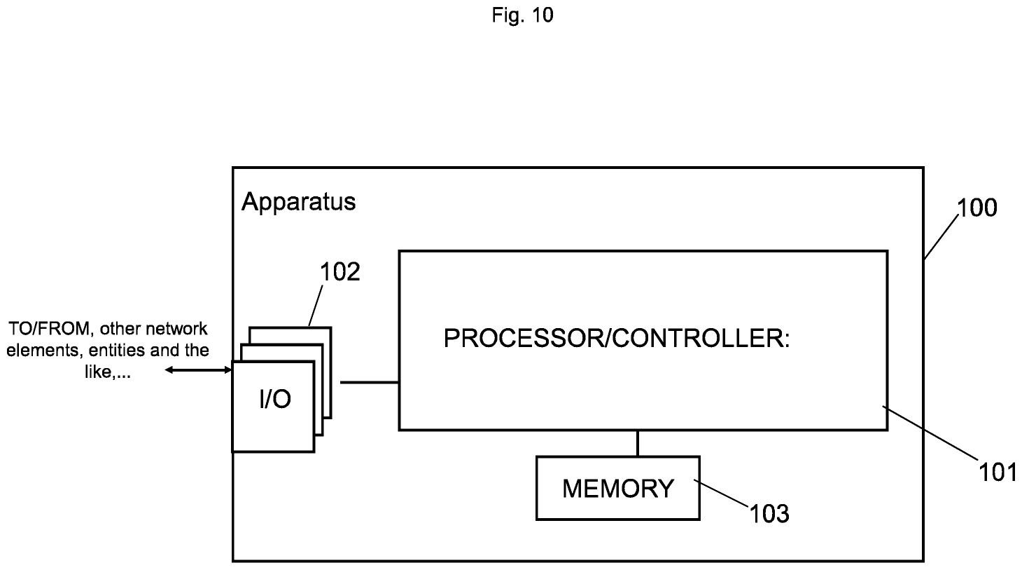

FIG. 10 is a block diagram illustrating another example of an apparatus according to some example versions of the present invention.

In FIG. 10, a block circuit diagram illustrating a configuration of an apparatus 100 is shown, which is configured to implement the above described various aspects of the invention. It is to be noted that the apparatus 100 shown in FIG. 10 may comprise several further elements or functions besides those described herein below, which are omitted herein for the sake of simplicity as they are not essential for understanding the invention. Furthermore, the apparatus may be also another device having a similar function, such as a chipset, a chip, a module etc., which can also be part of an apparatus or attached as a separate element to the apparatus, or the like.

The apparatus 100 may comprise a processing function or processor 101, such as a CPU or the like, which executes instructions given by programs or the like. The processor 101 may comprise one or more processing portions dedicated to specific processing as described below, or the processing may be run in a single processor. Portions for executing such specific processing may be also provided as discrete elements or within one or further processors or processing portions, such as in one physical processor like a CPU or in several physical entities, for example. Reference sign 102 denotes transceiver or input/output (I/O) units (interfaces) connected to the processor 101. The I/O units 102 may be used for communicating with one or more other network elements, entities, terminals or the like. The I/O units 102 may be a combined unit comprising communication equipment towards several network elements, or may comprise a distributed structure with a plurality of different interfaces for different network elements. The apparatus 100 further comprises at least one memory 103 usable, for example, for storing data and programs to be executed by the processor 101 and/or as a working storage of the processor 101.

The processor 101 is configured to execute processing related to the above-described aspects.

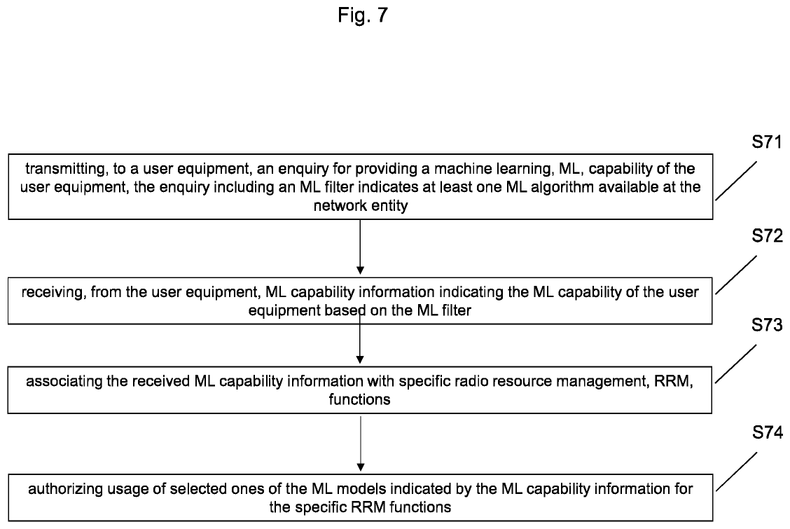

In particular, the apparatus 100 may be implemented in or may be part of a network entity, like a gNB, for example, and may be configured to perform processing as described in connection with FIG. 7.

Thus, according to some example versions of the present invention, there is provided an apparatus 100 for use in a network entity, like a gNB, for example, comprising at least one processor 101, and at least one memory 103 for storing instructions to be executed by the processor 101, wherein the at least one memory 103 and the instructions are configured to, with the at least one processor 101, cause the apparatus 100 at least to perform transmitting, to a user equipment, an enquiry for providing a machine learning, ML, capability of the user equipment, the enquiry including an ML filter indicates at least one ML algorithm available at the network entity, receiving, from the user equipment, ML capability information indicating the ML capability of the user equipment based on the ML filter, associating the received ML capability information with specific radio resource management, RRM, functions, and authorizing usage of selected ones of the ML models indicated by the ML capability information for the specific RRM functions.

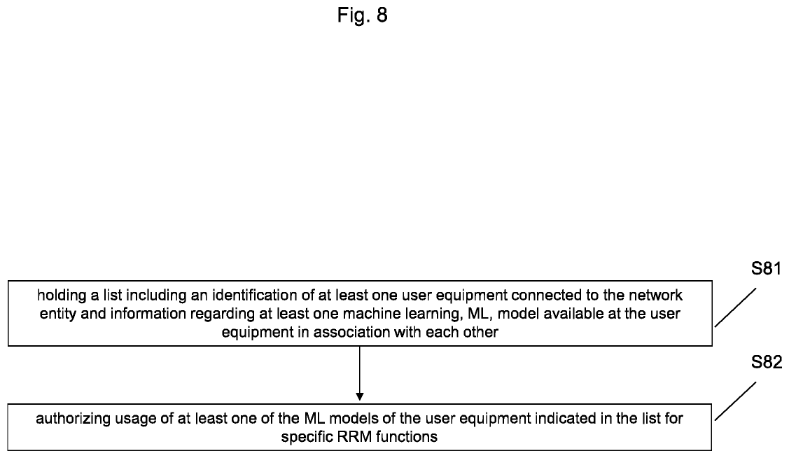

Additionally, the apparatus 100 may be implemented in or may be part of a network entity, like a gNB, for example, and may be configured to perform processing as described in connection with FIG. 8.

Thus, according to some example versions of the present invention, there is provided an apparatus 100 for use in a network entity, like a gNB, for example, comprising at least one processor 101, and at least one memory 103 for storing instructions to be executed by the processor 101, wherein the at least one memory 103 and the instructions are configured to, with the at least one processor 101, cause the apparatus 100 at least to perform holding a list including an identification of at least one user equipment connected to the network entity and information regarding at least one machine learning, ML, model available at the user equipment in association with each other, and authorizing usage of at least one of the ML models of the user equipment indicated in the list for specific RRM functions.

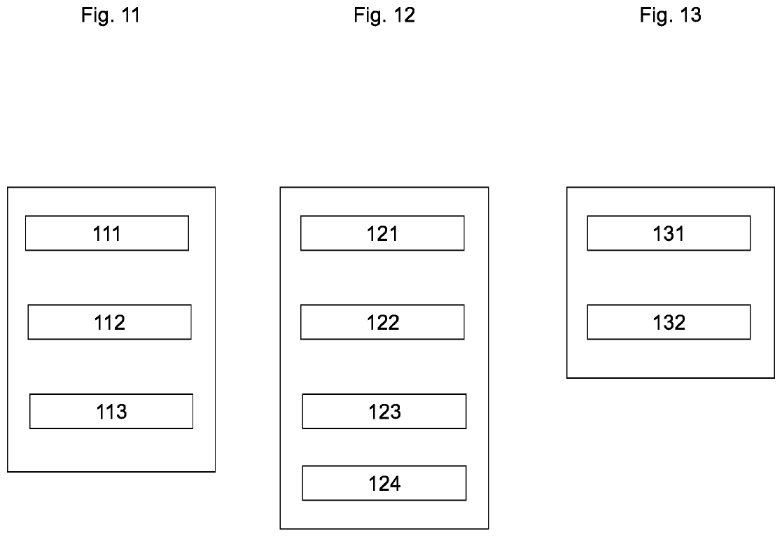

Further, the present invention may be implement by an apparatus for a user equipment comprising means for preforming the above-described processing, as shown in FIG. 11.

That is, according to some example versions of the present invention, as shown in FIG. 11, the apparatus for use in a user equipment comprises means 111 for receiving, from a network entity, an enquiry for providing a machine learning, ML, capability of the user equipment, the enquiry including an ML filter, indicating at least one ML algorithm available at the network entity, means 112 for generating ML capability information indicating at least one ML model available at the user equipment based on the ML filter received from the network entity, and means 113 for transmitting the generated ML capability information to the network entity.

Further, the present invention may be implement by an apparatus for a network entity comprising means for preforming the above-described processing, as shown in FIG. 12.

That is, according to some example versions of the present invention, as shown in FIG. 12, the apparatus for use in a network entity comprises means 121 for transmitting, to a user equipment, an enquiry for providing a machine learning, ML, capability of the user equipment, the enquiry including an ML filter indicates at least one ML algorithm available at the network entity, means 122 for receiving, from the user equipment, ML capability information indicating the ML capability of the user equipment based on the ML filter, means 123 for associating the received ML capability information with specific radio resource management, RRM, functions, and means 124 for authorizing usage of selected ones of the ML models indicated by the ML capability information for the specific RRM functions.

Further, the present invention may be implement by an apparatus for a network entity comprising means for preforming the above-described processing, as shown in FIG. 13.

That is, according to some example versions of the present invention, as shown in FIG. 13, the apparatus for use in a network entity comprises means 131 for holding a list including an identification of at least one user equipment connected to the network entity and information regarding at least one machine learning, ML, model available at the user equipment in association with each other, and means 132 for authorizing usage of at least one of the ML models of the user equipment indicated in the list for specific RRM functions.

Additionally, according to some example versions of the present invention, there is provided a computer program comprising instructions, which, when executed by an apparatus for use in a user equipment, cause the apparatus to perform receiving, from a network entity, an enquiry for providing a machine learning, ML, capability of the user equipment, the enquiry including an ML filter, indicating at least one ML algorithm available at the network entity, generating ML capability information indicating at least one ML model available at the user equipment based on the ML filter received from the network entity, and transmitting the generated ML capability information to the network entity.

Additionally, according to some example versions of the present invention, there is provided a computer program comprising instructions, which, when executed by an apparatus for use in a network entity, cause the apparatus to perform transmitting, to a user equipment, an enquiry for providing a machine learning, ML, capability of the user equipment, the enquiry including an ML filter indicates at least one ML algorithm available at the network entity, receiving, from the user equipment, ML capability information indicating the ML capability of the user equipment based on the ML filter, associating the received ML capability information with specific radio resource management, RRM, functions, and authorizing usage of selected ones of the ML models indicated by the ML capability information for the specific RRM functions.

Additionally, according to some example versions of the present invention, there is provided a computer program comprising instructions, which, when executed by an apparatus for use in a network entity, cause the apparatus to perform holding a list including an identification of at least one user equipment connected to the network entity and information regarding at least one machine learning, ML, model available at the user equipment in association with each other, and authorizing usage of at least one of the ML models of the user equipment indicated in the list for specific RRM functions.

The computer program product may comprise code means adapted to produce steps of any of the methods as described above when loaded into the memory of a computer.

According to some example versions of the present invention, there is provided a computer program product as defined above, wherein the computer program product comprises a computer-readable medium on which the software code portions are stored.

According to some example versions of the present invention, there is provided a computer program product as defined above, wherein the program is directly loadable into an internal memory of the processing device/apparatus.

According to some example versions of the present invention, there is provided a computer readable medium storing a computer program as set out above.

According to some example versions of the present invention, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Furthermore, the present invention may be implement by an apparatus for use in a user equipment comprising respective circuitry for preforming the above-described processing.

That is, according to some example versions of the present invention, there is provided an apparatus for use in a user equipment, comprising reception circuitry for receiving, from a network entity, an enquiry for providing a machine learning, ML, capability of the user equipment, the enquiry including an ML filter, indicating at least one ML algorithm available at the network entity, generation circuitry for generating ML capability information indicating at least one ML model available at the user equipment based on the ML filter received from the network entity, and transmission circuitry for transmitting the generated ML capability information to the network entity.

Furthermore, the present invention may be implement by an apparatus for use in a network entity comprising respective circuitry for preforming the above-described processing.

That is, according to some example versions of the present invention, there is provided an apparatus for use in a network entity, comprising transmission circuitry for transmitting, to a user equipment, an enquiry for providing a machine learning, ML, capability of the user equipment, the enquiry including an ML filter indicates at least one ML algorithm available at the network entity, reception circuitry for receiving, from the user equipment, ML capability information indicating the ML capability of the user equipment based on the ML filter, association circuitry for associating the received ML capability information with specific radio resource management, RRM, functions, and authorization circuitry for authorizing usage of selected ones of the ML models indicated by the ML capability information for the specific RRM functions.

Furthermore, the present invention may be implement by an apparatus for use in a network entity comprising respective circuitry for preforming the above-described processing.

That is, according to some example versions of the present invention, there is provided an apparatus for use in a network entity, comprising holding circuitry for holding a list including an identification of at least one user equipment connected to the network entity and information regarding at least one machine learning, ML, model available at the user equipment in association with each other, and authorization circuitry for authorizing usage of at least one of the ML models of the user equipment indicated in the list for specific RRM functions.

For further details regarding the functions of the apparatus and the computer program, reference is made to the above description of the methods according to some example versions of the present invention, as described in connection with FIGS. 6 to 8.

In the foregoing exemplary description of the apparatus, only the units/means that are relevant for understanding the principles of the invention have been described using functional blocks. The apparatus may comprise further units/means that are necessary for its respective operation, respectively. However, a description of these units/means is omitted in this specification. The arrangement of the functional blocks of the apparatus is not to be construed to limit the invention, and the functions may be performed by one block or further split into sub-blocks.

When in the foregoing description it is stated that the apparatus (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is to be construed to be equivalent to an expression such as “means for”).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

For the purpose of the present invention as described herein above, it should be noted that
method steps likely to be implemented as software code portions and being run using a processor at an apparatus (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the aspects/embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the aspects/embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components, APU (Accelerated Processor Unit), GPU (Graphics Processor Unit) or DSP (Digital Signal Processor) components;
devices, units or means (e.g. the above-defined apparatuses, or any one of their respective units/means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

It is to be noted that the aspects/embodiments and general and specific examples described above are provided for illustrative purposes only and are in no way intended that the present invention is restricted thereto. Rather, it is the intention that all variations and modifications, which fall within the scope of the appended claims, are covered.

1-22. (canceled)

23. An apparatus comprising at least one processor, and at least one memory for storing instructions to be executed by the processor, wherein the at least one memory and the instructions are configured to, with the at least one processor, cause the apparatus at least to perform:
receiving, from a network entity, an enquiry for providing a machine learning, ML, capability of the user equipment, the enquiry including an ML filter, indicating at least one ML algorithm available at the network entity,
generating ML capability information indicating at least one ML model available at the user equipment based on the ML filter received from the network entity, and
transmitting the generated ML capability information to the network entity.

24. The apparatus according to claim 23, further caused to perform:
receiving, from the network entity, a ML reconfiguration request including an information indicating the ML models, which are authorized by the network entity for specific radio resource management, RRM, functions.

25. The apparatus according to claim 23, further caused to perform:
generating a update notification indicating that the ML capability information of the user equipment has been updated, and
transmitting the notification to the network entity.

26. The apparatus according to claim 25, further caused to perform:
receiving, from the network entity, an inquiry for providing updated ML capability of the user equipment, the enquiry including the ML filter,
generating ML capability update information indicating at least one updated ML model available at the user equipment based on the ML filter received from the network entity, and
transmitting the generated ML capability update information to the network entity.

27. The apparatus according to claim 25, wherein:
the update notification is generated when a state of a ML model changes, when a new ML model is downloaded to the user equipment, or when the user equipment subscribes to a new ML assisted functionality.

28. An apparatus comprising at least one processor, and at least one memory for storing instructions to be executed by the processor, wherein the at least one memory and the instructions are configured to, with the at least one processor, cause the apparatus at least to perform:
transmitting, to a user equipment, an enquiry for providing a machine learning, ML, capability of the user equipment, the enquiry including an ML filter indicates at least one ML algorithm available at the network entity,
receiving, from the user equipment, ML capability information indicating the ML capability of the user equipment based on the ML filter,
associating the received ML capability information with specific radio resource management, RRM, functions, and
authorizing usage of selected ones of the ML models indicated by the ML capability information for the specific RRM functions.

29. The apparatus according to claim 28, wherein
the authorizing comprises
authorization of allowing the usage of selected ones of the ML models for the specific RRM functions,
de-authorization of prohibiting the usage of selected ones of the ML models for the specific RRM functions, and
re-authorization of allowing the usage of selected ones of the ML models for a different set of RRM functions.

30. The apparatus according to claim 29, further caused to perform:
transmitting, to the user equipment, a ML reconfiguration request including information indicating the authorization of the ML models, which are authorized for the specific RRM functions.

31. The apparatus according to claim 29, further caused to perform:
receiving, from the user equipment, an update notification indicating that the ML capability information of the user equipment has been updated, and
storing an identification of the user equipment in connection with an information that ML capability of the user equipment has been updated.

32. The apparatus according to claim 31, further caused to perform:
transmitting, to the user equipment, an enquiry for providing updated ML capability of the user equipment, the enquiry including the ML filter,
receiving, from the user equipment, ML capability update information indicating the updated ML capability of the user equipment based on the ML filter,
associating the received ML capability update information with specific radio resource management, RRM, functions, and
authorizing usage of selected ones of the updated ML models indicated by the ML capability update information for the specific RRM functions.

33. The apparatus according to claim 32, further caused to perform:
transmitting, to the user equipment, an updated ML reconfiguration request including information indicating the updated authorization of the ML models, which are authorized for the specific RRM functions.

34. The apparatus according to claim 28, further caused to perform:
transmitting, to a central network entity, a ML capability information indication indicating the ML capability of the UE and the authorization of the ML models.

35. The apparatus according to claim 33, further caused to perform:
transmitting the ML capability information indication to the central network entity when determining that the UE moves to radio resource connection, RRC, idle state.

36. The apparatus according to claim 28, further caused to perform:
transmitting the ML capability information indication to another network node, when it is determined that the UE has been handed over to the another network node.

37. A method for use in a user equipment, comprising:
receiving, from a network entity, an enquiry for providing a machine learning, ML, capability of the user equipment, the enquiry including an ML filter, indicating at least one ML algorithm available at the network entity,
generating ML capability information indicating at least one ML model available at the user equipment based on the ML filter received from the network entity, and
transmitting the generated ML capability information to the network entity.
